(19) United States
(12) Patent Application Publication
(10) Pub. No.: US 2006/0050865 A1
(43) Pub. Date: Mar. 9, 2006

(54) System and method for adapting the level of instructional detail provided through a user interface

(75) Inventors: Philip T. Kortum, Austin, TX (US); Robert R. Bushey, Cedar Park, TX (US); Benjamin Anthony Knott, Round Rock, TX (US); Marc Andrew Sullivan, Austin, TX (US)

Correspondence Address: TOLER & LARSON & ABEL L.L.P., 5000 PLAZA ON THE LAKE STE 265, AUSTIN, TX, 78746, US

(73) Assignee: SBC Knowledge Ventures, LP

(21) Appl. No.: 10/935,726

(22) Filed: Sep. 7, 2004

(51) Int. Cl. H04M 3/00

(52) U.S. Cl. 379/265.07; 379/265.06

(57) ABSTRACT

A system and method for adapting the level of instructional detail provided through a user interface are disclosed. A method incorporating teachings of the present disclosure may include, for example, providing a user with a first level of instructional detail for completing a task flow. A skill level score for the user may be generated that indicates how proficiently the user is interacting with a computing platform to progress through the task flow. In some cases, it may be recognized that the skill level score suggest moving to a different level of instructional detail.

### BACKGROUND

From a high level, a user interface (UI) is a part of a system exposed to the user. The system may be any system with which a user interacts such as a mechanical system, a computer system, a telephony system, etc. As systems have become more complex, system designers have begun to spend more time and money in the hopes of developing highly usable interfaces. Unfortunately, what may be useable for one user may not be useable for another.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 presents a flow diagram for adapting a level of instructional detail within a user interface in accordance with teachings of the present disclosure;

FIG. 2 presents an illustrative diagram of a user interface system that facilitates near real time modification of user interface support in accordance with teachings of the present disclosure; and

FIG. 3 illustrates one embodiment of a Graphical User Interface (GUI) that facilitates the tracking of a user skill level and the subsequent modification of an instructional detail level in accordance with teachings of the present disclosure.

The use of the same reference symbols in different drawings indicates similar or identical items.

### DETAILED DESCRIPTION OF THE DRAWINGS

As suggested above, user interface design has become increasingly important. System designers are developing more and more complex systems, and the intended users of these systems must be able to effectively and efficiently interact with them. The challenge of designing a usable interface is often compounded by the fact that the intended users may not be equally adept or experienced at using a given modality, interacting with a specific interface, or navigating through a task flow associated with the overall system.

The following discussion focuses on a system and a method for adapting the level of instructional detail provided through a user interface in hopes of addressing some of these challenges. Much of the following discussion focuses on how a system may observe a user's interaction with a GUI or Telephony User Interface (TUI) and vary up or down the level of instructional based on its observation. In particular, several of the discussed embodiments describe how an organization can improve customer facing applications and user experiences.

While the following discussion may focus, at some level, on this implementation of adaptive interfaces, the teachings disclosed herein have broader application. Although certain embodiments are described using specific examples, it will be apparent to those skilled in the art that the invention is not limited to these few examples. Accordingly, the present invention is not intended to be limited to the specific form set forth herein, but on the contrary, it is intended to cover such alternatives, modifications, and equivalents, as can be reasonably included within the spirit and scope of the disclosure.

From a high level, providing an adaptive interface in a manner that incorporates teachings disclosed herein may involve providing a user with a first level of instructional detail for completing a task flow. A skill level score for the user may be generated or maintained that indicates how proficiently the user is interacting with a computing platform to progress through the task flow. In some cases, it may be recognized that the skill level score suggests moving to a different level of instructional detail.

In some embodiments, a system implementing such a methodology may adaptively provide differing levels of instructional detail depending upon the actions of the user. If the user is proceeding through an interface with little to no difficulty, the system may gradually reduce the level of detail in the interface. If the user begins to make errors while using the interface, the level of detail in subsequent modules may be increased to help improve the user's performance and/or experience. In some embodiments, the adaptive interface system may be constantly monitoring and adjusting the interface—hoping to maintain some near optimum level of detail for a given user.

In many cases, an interface may be designed to provide a single set of instructions for guiding a user through a process or task flow. Frequently, a great deal of time and money are invested in making such an interface user friendly. A challenge arises for the interface designer if it is believed that the intended users of the interface will likely have very different skill levels in navigating through the interface and/or completing an associated task flow.

To address this challenge, the interface may be designed to include an error correction routine that activates in response to a specific error. For example, an error correction routine may recognize that a user has failed to populate an online template field. In response, the routine may point out the failing and restate the need to properly populate the form. While this technique may somewhat improve usability, an interface designer may find a more adaptive interface to be a better solution.

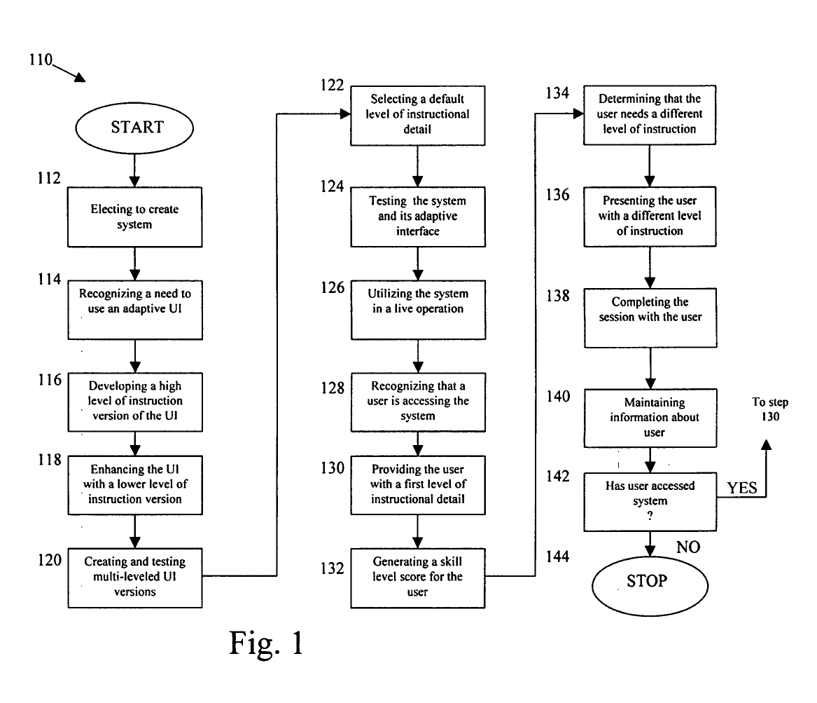

As mentioned above, FIG. 1 presents a technique 110 for adapting a level of instructional detail within a user interface in accordance with teachings of the present disclosure. At step 112, an entity may elect to create a system that will allow for user interaction. The system may be, for example, a mechanical system, a computer system, a telephony system, some other system, or a combination thereof. For example, the system may include both a computing element and a telephony element. A banking system may be one example of such a composite system. In practice, a system designed to allow a user to interact with a banking system via a telephony user interface (TUI) may permit users to accomplish several tasks like check a balance, transfer funds, modify account details, etc.

At step 114, the system designer of such a banking system may recognize a need to develop a user interface for the system that provides a high level of usability. In some cases, the system designer may recognize that the intended users of the system may approach the system with different experience and/or skill levels. As such, the designer may elect to develop the user interface into an adaptive interface.

At step 116, a user interface may be developed with a high level of instruction. The high level of instruction may help ensure that even a novice user can navigate through task flows associated with available features. Novice users may effectively need additional assistance as they work through the system to accomplish their objective.

More experienced users, on the other hand, may find such a high degree of elemental instruction to be annoying or cumbersome. As such, at step 118, the user interface may be enhanced such that a lower level of user instruction is available to more experienced users. At step 120, several additional levels of user instruction may be developed and tested for the system. As a result of steps 116, 118, and 120, there may be multiple levels of user instruction that can be presented in connection with the user interface. For example, there may be a high level of instruction, a moderate level of instruction, and a low level of instruction. The number of instructional levels may range, for example, from two to ten or higher—depending upon design concerns and implementation detail.

At step 122, a system designer may determine that most intended users of the system would have a moderate skill level. As such, the system designer may elect to establish a moderate level of instruction as a default level. As such, when a user initially accesses the system being designed, the user may be presented with a user interface that includes a moderate level of instructional detail.

At step 124, the system and its adaptive interface may be tested and put into a live operation at step 126. The live operation may include, for example, a customer service center, a call center, a banking support center, an online website, a client-server application, a personal computer application, some other application involving a user interacting with a system, and/or a combination thereof.

At step 128, a user may engage the system, and at step 130 the system may provide the user with a first level of instructional detail for completing a task flow. Task flows could include, for example, a series of steps to be completed in order to accomplish a task, such as paying bills, checking a balance, inquiring about a service, searching available options, resolving a service issue, populating a form, etc. In some embodiments, the system may adjust the level of instructional detail provided to the user based on a skill level score. The skill level score for a user may attempt to quantify how proficiently the user interacts with the system to progress through a task flow. The skill level score may be determined in several different ways. For example, a system may at least partially base the skill level score on the speed at which the user is progressing though the task flow and/or a number of times the user accesses a help utility. The system may consider a complexity level of issues about which a user seeks help and/or the number of errors made by the user. The system may recognize or “know” the user and may consider a past interaction between the user and the system when developing the skill level score. The system may also prompt the user to input a self-evaluation score. In some embodiments, the system may use a combination of these and other scoring techniques to determine a user skill level.

However accomplished, a skill level score or indicator may be generated at step 132. At step 134, the system may consider the score and determine that the user needs a different level of instructional detail. In practice, the system may be capable of moving to the different level of instructional detail at several different points in time. The system may move the user to a different level as soon as the system determines that the user's skill level warrants a move. The system may move the user to a different level prior to the user beginning a new task flow, prior to completing a current task flow, after completing a current task flow, at the start of a subsequent interaction between the user and the system, etc.

At step 136, the user may be presented with a different level of instructional detail, and the user may complete a session with the system at step 138. At step 140, the system may maintain and/or update information about the user who completed the session at step 138. The information may include, for example, a collection of identifiers for the user (such as username/password combinations or Caller ID information), a skill level for the user, a preference of the user (such as language preferences or font size preferences), and/or an indication of whether the user skill level is changing and if so how quickly.

At step 142, the system may determine if the same or a different user has accessed the system. If no user is accessing the system, technique 110 may progress to stop at step 144. If a user is accessing the system, technique 110 may loop back to step 130. In some cases, the system may consider maintained information to help identify the user and to determine a presumed skill level for the user. The maintained information may be utilized at step 130 to assist in starting the user with a correct level of instructional detail. In some embodiments, the system may not “know” the user and may elect to begin at step 130 with a default level of instructional detail.

Though the various steps of technique 110 are described as being performed by a specific actor or device, additional and/or different actors and devices may be included or substituted as necessary without departing from the spirit of the teachings disclosed herein. Similarly, the steps of technique 110 may be altered, added to, deleted, re-ordered, looped, etc. without departing from the spirit of the teachings disclosed herein.

As mentioned above, a designer may believe that a typical user will interact with an interface infrequently. As such, the designer may develop long, detailed instructions to guide the user's interaction through the interface, and set these instructions as the default level. On the other hand, if the designer believes the typical user will interact with the interface frequently, the designer may use a short, terse instructional set as the default level. Advantageously, if the designer's assumptions about the user population do not hold, an adaptive interface may help avoid user frustration.

If the system detects that a user is easily navigating the interface with no errors, the system may adaptively decrease the level of detail for the entire interface, not just for commands that have been successfully executed in the past. If a measure indicates that the user is encountering difficulties (a specific error, or an increase in time between actions) the interface may be designed to slowly add detail back to the entire interface.

Additionally, in speech applications, the system may listen for speech outside of the system's designed language and intelligently offer another language if the user encounters difficulty. For example, a user may begin in an English level mode and encounter difficulty. A speech engine associated with the system may “hear” Spanish (e.g., users may begin talking to themselves in their native tongue), and the instructional level may automatically change to Spanish and/or offer to conduct the transaction in Spanish.

Other speech cues may also be used to detect when users require extra help or a change in instructional level. For example, speech applications may recognize certain words or expressions that are highly correlated with user frustration and include these expressions in the system's grammar. The system logic may then be designed such that the system responds with context-dependent help messages or changes in instructional level when these expressions are recognized by the system.

User stress levels may also alter speech patterns in specific ways. As such, a system designer may elect to deploy a speech application capable of detecting speech patterns that are associated with increasing stress levels. In response, the system may offer more detailed and/or helpful prompts and instructions to provide additional assistance for these users.

As mentioned above, the interface may also be programmed to take direct action in response to user inputs related to the level of instruction that is offered. For example, the interface could start out in verbose mode and at any given time the user could interrupt and say “less detail.”. The “less detail” command may be applied to the current instruction set only, or it could be applied to an entire interface. By allowing user self-evaluation input, the system may facilitate a user's moving back and forth between more and less detail as a given situation or task flow requires.

By way of example, in a visual domain, a user of a television set top box may try to search for a specific movie title. The remote provided with the system may have a built in keyboard, but the keyboard may be hiding the main controls of the remote. The user may be presented with a first screen including a GUI element like “search name” next to a field that needs to be populated by the user. The user may not know what to do in response to this screen. As such, the user may do nothing or press an incorrect key, etc. In response, the set top box system may change the instructional level of the interface and present a second screen that includes instructions showing the user how to open the remote and enter the name of a movie with the now-exposed keyboard. After several successful uses of the keyboard, the instructional level may be lowered back to the first screen level.

In a speech-enabled self-service application, a user may begin with minimal assistance. As the user proceeds into the application, an “assistance counter” may be incremented each time the user encounters difficulties. As the “assistance counter” becomes larger, the application may increment up the level of instruction provided. For example, a default level prompt may be: “Are you calling about charges on your bill?”. A prompt that provides more assistance may be: “I'd like to know if you're calling about charges on your bill. For example, a long distance charge, or the cost of your monthly Internet fees. If that's why you're calling, just say yes. If not, say no.”

An adaptive system may include, for example, the following interaction: SYSTEM: “Please tell me which phone service you'd like to find out about.” USER: [silence]. SYSTEM INCREMENTS ASSISTANCE COUNTER & PLAYS A MORE DETAILED PROMPT: “This is an automated system to help you to find out about our phone services. You can speak your answers to the questions I ask. Once I determine which service you'd like information about, I'll tell you which topics I can help you with for that service.”

Similarly, the adaptive system may also include this interaction: SYSTEM: “Please tell me which phone service you'd like to find out about.” USER: “Caller ID” SYSTEM COMMITS A FALSE ACCEPTANCE ERROR: “Okay, CallNotes.” USER EXPRESSES FRUSTRATION: “Oh, darn it!” SYSTEM DETECTS FRUSTRATION AND OFFERS HELP: “Remember, if you are having difficulties with this system, you can start over at any time by saying “Main Menu.”

Adaptive interface systems like these may be significantly better than alternative interfaces, because the ability to adapt allows the interface to better optimize the instruction level to match the user's needs with little or no intervention from the user, thus allowing for a better, more successful and more pleasant experience for the user.

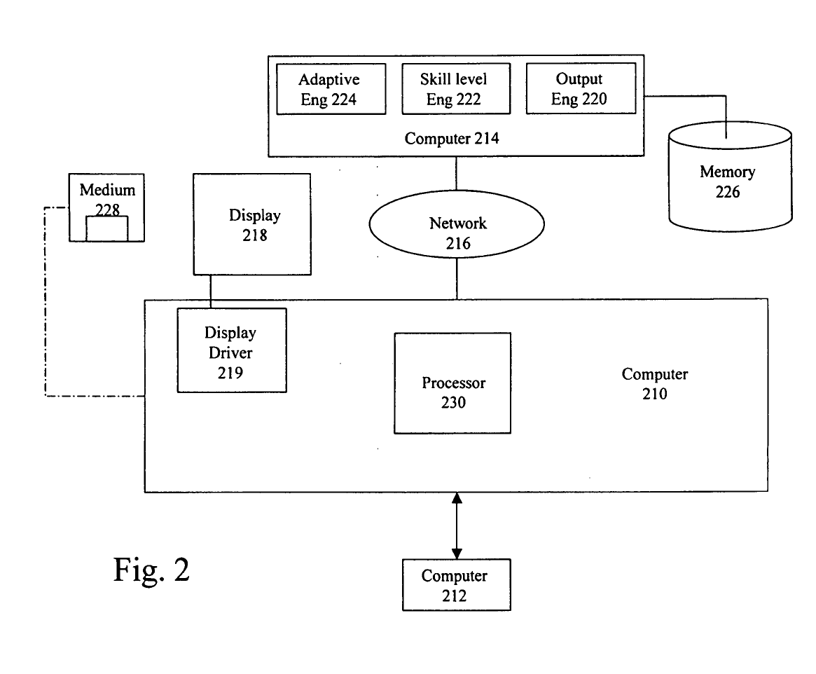

As mentioned above, FIG. 2 presents an illustrative diagram of a user interface system that facilitates near real time modification of user interface support in accordance with teachings of the present disclosure. In the embodiment of FIG. 2, a computer 210 may be accessed by a user 212. User 212 may want to interact with a system, and the system may allow for this interaction via a user interface. In one embodiment, the system being accessed may be maintained at and/or by another computer 214. In practice, computer 214 may be accessible via network 216. Examples of computer 210 include, but are not limited to, a telephonic device, a desktop computer, a notebook computer, a tablet computer, a set top box, a smart telephone, and a personal digital assistant. Examples of computer 214 include, but are not limited to, a peer computer, a server, and a remote information storage facility. In one embodiment, computer 214 may provide a TUI interface. In the same or another embodiment, computer 214 may present a Web interface via a Web site that provides for GUI-based interaction.

Examples of computer network 216 include, but are not limited to, the Public Internet, an intranet, an extranet, a local area network, and a wide area network. Network 216 may be made up of or include wireless networking elements like 802.11(x) networks, cellular networks, and satellite networks. Network 216 may be made up of or include wired networking elements like the public switched telephone network (PSTN) and cable networks.

As indicated herein, a method incorporating teachings of the present disclosure may include providing a graphical user interface (GUI) using computer 210. The GUI may be presented on display 218 and may allow user 212 to interact with a remote or local computing platform. In practice, an output engine 220, shown as executing on Computer 214, may communication to the user a GUI having a first level of instructional detail for accomplishing a task. A skill level engine 222 may also be executing on computer 214 and may maintain a skill level indicator for the user. The skill level indicator may be at least partially based on a single metric and/or a combination of metrics like a number of times the user accesses a help utility, a complexity level of issues about which the user sought help, a past interaction between the user and computer 214, a speed at which the user is progressing though a task flow, and a number of errors made by the user while progressing through the task flow.

However calculated, an adaptive engine 224 may consider the skill level indicator and initiate communication of a change indicator to output engine 220. The change indicator may “tell” output engine 220 that it needs to communicate a different level of instructional detail to the user. The user may, for example, need more, less, and/or different instructions for completing a task flow. Different instructions may include, for example, altering a modality of presented instructions or a language of presented instructions.

In the depicted embodiment, a memory 226 may be communicatively coupled to computer 214 and may be storing information representing at least a first available and a second available level of instructional detail for guiding a user through a given task flow. Memory 226 may also be maintaining information about various users and what level of instruction computer 214 believes each of those users needs. Memory 226 may take several different forms such as a disk, a compact disk, a DVD, flash, an onboard memory made up of RAM, ROM, flash, etc., some other memory component, and/or a combination thereof. Similarly, computers, computing platforms, and engines may be implemented by, for example, a processor, hardware, firmware, and/or an executable software application.

In operation, computers 210 and 214 may perform several functions. For example, one or both of computers 210 and 214 may facilitate receiving a selection of one or more icons, activating a selectable icon, and initiating presentation of a given element. Moreover, one or both of computers 210 and 214 may assist in providing a user with an adaptive interface.

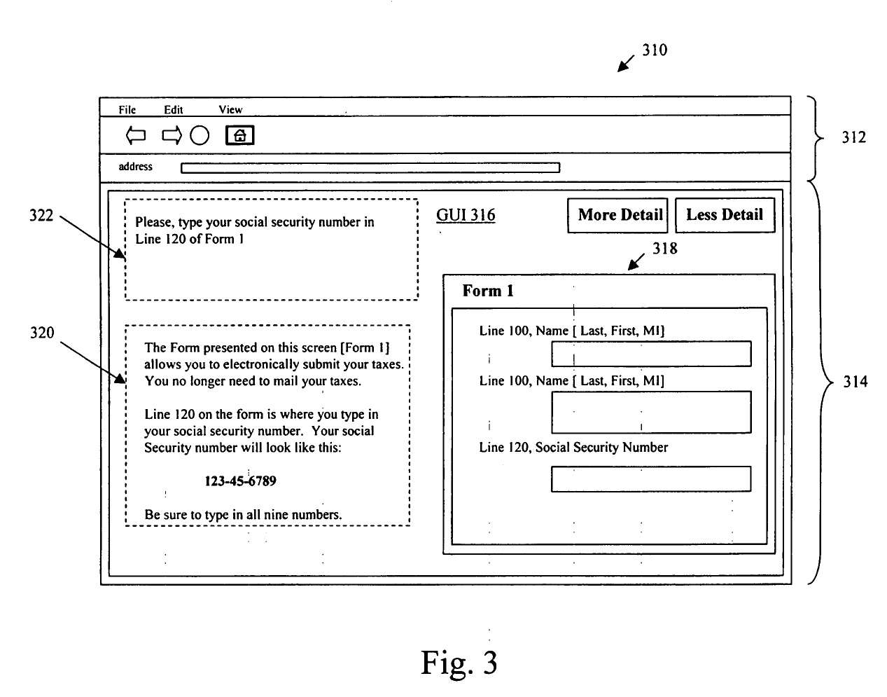

With some implementations, computer 210 may be tasked with providing at least some of the above-discussed features and functions. As such, computer 210 may make use of a computer readable medium 228 that has instructions for directing a processor like processor 230 to perform those functions. As shown, medium 228 may be a removable medium embodied by a disk, a compact disk, a DVD, a flash with a Universal Serial Bus interface, and/or some other appropriate medium. Similarly, medium 228 may also be an onboard memory made up of RAM, ROM, flash, some other memory component, and/or a combination thereof. In operation, instructions may be executed by a processor, such as processor 230, and those instructions may cause display 218 to present user 212 with information about and/or access to an adaptive user interface for completing some task. One example of an adaptive interface display that may be presented to user 212 is shown in FIG. 3.

In some cases, medium 228 may also include instructions that allow a computing platform to present a user with an initial interface selected from between a first and a second version of a user interface. In some cases, the first version of the user interface may include greater instructional detail for completing a task flow than the second version of the user interface. The instructions may also allow the platform to consider an indicator of a success level of a user at completing the task flow and to initiate presentation of a different interface version.

Depending upon design details, additional instructions may provide for developing an indicator of the success level from a tracked metric like the number of times the user accesses a help utility, the complexity level of issues about which the user sought help, a past interaction between the user and the computing platform, a speed at which the user is progressing though a task flow, and a number of errors made by the user while progressing through the task flow. The additional instructions may also allow for monitoring the indicator on an ongoing basis, maintaining a plurality of versions of the user interface, and formatting the initial interface for presentation via an interface modality like a GUI, a TUI, a textual interface, a video interface, a gesture-based interface, and/or a mechanical interface.

As mentioned above, FIG. 3 illustrates one embodiment of a Graphical User Interface (GUI) display 310 that facilitates the tracking of a user skill level and the subsequent modification of an instructional detail level in accordance with teachings of the present disclosure. As shown, display 310 includes a navigation bar portion 312 and a display pane 314. In operation, a computer like computer 210 of FIG. 2 may have a display device capable of presenting a user with a browser or browser-like screen shot of display 310.

As shown, display 310 includes a GUI 316 that represents a user interface to a remote system. In practice, a user may engage GUI 316 to interact with the remote system. The embodiment depicted in FIG. 3 shows a multiple element structure for GUI 316. This structure may be presented in several other ways. For example, the display may be presented in a spreadsheet or a row-based format.

In the depicted embodiment, GUI 316 includes More Detail and Less Detail buttons for manually altering the level of provided detail. GUI 316 also includes a Form 1 in window 318. In practice, Form 1 may be presented to a user using a larger portion of the display 314. The text blocks 320 and 322 may not be displayed to the user and may instead represent alternative levels of instruction that could be included within window 318.

As shown, window 318 includes a relatively terse level of instruction. For example, within Form 1, a blank box appears next Line 120, and the only provided instruction is “Social Security Number”. Advanced users may know to input their social security number in the provided box, and those same users may appreciate the minimal level of instruction. A moderately skilled user may need more instruction, and the computer may recognize this in a number of ways. The user may make a mistake populating Form 1, may request more detail by activating the More Detail button, and/or may take an inordinate amount of time completing Form 1. However determined, the computed may adapt GUI 316 to include a higher level of instructional. For example, the computer may increment to instructions like those included in box 322. If this level remains too low, the computer may increment again to instructions like those in box 320.

In some embodiments, the computer may not have additional instructional detail to provide, and may elect to switch modalities, add modalities, initiate a communication session with the user, etc. The communication session could involve, for example, a live assistant via an Instant Messaging session or a Voice over Internet Protocol call. It will be apparent to those skilled in the art that the disclosure herein may be modified in numerous ways and may assume many embodiments other than the preferred forms specifically set out and described herein.

Accordingly, the above-disclosed subject matter is to be considered illustrative, and not restrictive, and the appended claims are intended to cover all such modifications, enhancements, and other embodiments that fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of modifying a level of instructional detail comprising:
providing a user with a first level of instructional detail for completing a task flow;
generating a skill level score for the user that indicates how proficiently the user interacts with a computing platform to progress through the task flow; and
recognizing that the skill level score suggest moving to a different level of instructional detail.

2. The method, as recited in claim 1, further comprising moving to the different level of instructional detail prior to the user beginning a new task flow.

3. The method of claim 2, further comprising moving to the different level of instructional detail prior to the user completing the task flow.

4. The method of claim 2, further comprising moving to the different level of instructional detail after the user completes the task flow.

5. The method of claim 1, wherein the user interacts with the computing platform via a GUI.

6. The method of claim 1, wherein the user interacts with the computing platform via TUI.

7. The method of claim 1, wherein the computing platform is local to the user.

8. The method of claim 1, wherein the computing platform is remote from the user.

9. The method of claim 1, further comprising at least partially basing the skill level score on a number of times the user accesses a help utility.

10. The method of claim 1, further comprising at least partially basing the skill level score on a complexity level of issues about which user seeks help.

11. The method of claim 1, further comprising at least partially basing the skill level score on a past interaction between the user and the computing platform

12. The method of claim 1, further comprising at least partially basing the skill level score on a speed at which the user is progressing though the task flow.

13. The method of claim 1, further comprising at least partially basing the skill level score on a number of errors made by the user while progressing through the task flow.

14. The method of claim 1, further comprising at least partially basing the skill level score on a self-evaluation score provided by the user.

15. The method of claim 1, wherein the different level of instructional detail includes more instructional detail than the first level of instructional detail.

16. The method of claim 1, wherein the different level of instructional detail includes less instructional detail than the first level of instructional detail.

17. The method of claim 1, wherein the different level of instructional detail comprises an additional modality of instructional detail.

18. The method of claim 17, wherein the first level of instructional detail provides information to the user via a visual modality and the additional modality comprises an auditory modality.

19. An instructional detail modifying method, comprising:
presenting an interface to a user that includes a first level of instructional detail for accomplishing a task;
determining that the user needs a different level of instructional detail; and
providing the user with a second level of instructional detail via the interface.

20. The method of claim 19, further comprising moving to the different level of instructional detail prior to the user beginning a new task flow.

21. The method of claim 19, further comprising moving to the different level of instructional detail prior to the user completing the task flow.

22. The method of claim 19, further comprising moving to the different level of instructional detail after the user completes the task flow.

23. The method of claim 19, wherein the user interacts with the computing platform via a GUI.

24. The method of claim 19, wherein the user interacts with the computing platform via a TUI.

25. The method of claim 19, wherein the computing platform is local to the user.

26. The method of claim 19, wherein the computing platform is remote from the user.

27. The method of claim 19, the method further comprising of at least partially basing the skill level score on a number of times the user accesses a help utility

28. The method of claim 19, wherein a complexity level of issues about which user seeks help.

29. The method of claim 19, wherein the step of determining that the user needs a different level of instructional detail further comprises considering a past interaction between the user and the computing platform.

30. The method of claim 19, wherein the step of determining that the user needs a different level of instructional detail further comprises considering a speed at which the user is progressing though the task flow.

31. The method of claim 19, wherein the step of determining that the user needs a different level of instructional detail further comprises considering a number of errors made by the user while progressing through the task flow.

32. The method of claim 19, wherein the step of determining that the user needs a different level of instructional detail further comprises considering a self-evaluation score provided by the user.

33. The method of claim 19, wherein the different level of instructional detail includes more instructional detail than the first level of instructional detail.

34. The method of claim 19, wherein the different level of instructional detail includes less instructional detail than the first level of instructional detail.

35. The method of claim 19, further comprising providing an additional modality of instructional detail.

36. The method of claim 19, further comprising providing the user with a third level of instructional detail.

37. An adaptive instructional level system, comprising:
an interface operable to allow a user to interact with a computing platform;
an output engine executing on the computing platform, the output engine operable to initiate communication to the user via the interface a first level of instructional detail for accomplishing a task;
a skill level engine executing on the computing platform, the skill level engine operable to maintain a skill level indicator for the user; and
an adaptive engine executing on the computing platform, the adaptive engine operable to consider the skill level indicator and to initiate communication of a change indicator to the output engine indicating a need to communicate a different level of instructional detail to the user.

38. The system of claim 37, further comprising a memory communicatively coupled to the computing platform, the memory maintaining information representing at least a first available and a second available level of instructional detail for guiding a user interaction.

39. The system of claim 38, wherein the different level of instructional detail is the second available level of instructional detail.

40. The system of claim 37, further comprising a memory communicatively coupled to the computing platform, the memory maintaining information representing at least a first available, a second available level, a third available level, and a fourth available level, of instructional detail for guiding a user interaction.

41. The system of claim 37, wherein the skill level indicator is at least partially based on a metric selected from a group consisting of a number of times the user accesses a help utility, a complexity level of issues about which the user sought help, a past interaction between the user and the computing platform, a speed at which the user is progressing though a task flow, and a number of errors made by the user while progressing through the task flow.

42. A computer readable medium comprising instructions for:
electing to present a user with an initial interface selected from a first and a second version of a user interface, wherein the first version of the user interface comprises greater instructional detail for completing a task flow than the second version of the user interface;
considering an indicator of a success level of a user at completing the task flow; and
initiating presentation of a different interface version.

43. The medium of claim 42, wherein the initial interface is the first version of the user interface, and the different interface version is the second version of the interface.

44. The medium of claim 42, further comprising instructions for determining the indicator of the success level from at least one of a metric selected from a group consisting of a number of times the user accesses a help utility, a complexity level of issues about which the user sought help, a past interaction between the user and the computing platform, a speed at which the user is progressing though a task flow, and a number of errors made by the user while progressing through the task flow.

45. The medium of claim 44, further comprising instructions for monitoring the indicator on an ongoing basis.

46. The medium of claim 44, further comprising instructions for maintaining a plurality of versions of the user interface.

47. The medium of claim 42, further comprising instructions for formatting the initial interface for presentation via an interface modality selected from a group consisting of a GUI, a TUI, a textual interface, a video interface, a gesture-based interface, and a mechanical interface.
